(19) United States
(12) Patent Application Publication
(10) Pub. No.: US 2004/0194024 A1
(43) Pub. Date: Sep. 30, 2004

(54) Tool for analysis of item attributes

(76) Inventor: Richard A Marzan, Allison Park, PA (US)

Correspondence Address: FERENCE & ASSOCIATES, 400 BROAD STREET, PITTSBURGH, PA, 15143, US

(21) Appl. No.: 10/484,540

(22) PCT Filed: Jul. 18, 2001
(86) PCT No.: PCT/US01/22642

(51) Int. Cl. G06F 15/00

(52) U.S. Cl. 715/513

(57) ABSTRACT

Processes and arrangements for assessing the value of an item in the remarketing market. Involved are the creation of a report form having screen (50), search (60), method (70), and chart attributes (100), facilitating access to a data set to which the report form is to be applied, applying said report form to said data set; and displaying said data in accordance with said report form. An illustrative example of an application of the contemplated processes and arrangements can be appreciated in connection with determining the value of a vehicle in the remarketing market.

### TECHNICAL FIELD

The present invention generally relates to methods and apparatus for assessing the value of an item in the remarketing market, and in particular the value of a vehicle in the remarketing market.

### BACKGROUND ART

For a variety of reasons, the leasing of items—rather than the outright purchase of items—is increasing by end users of the items. In a typical lease transaction, a finance company purchases the item and then leases (or rents) the use of the item to the end user for the term of lease. At the end of the lease term, a number of things typically occur, including the end user relinquishing possession of the item and the item being eventually being remarketed, or sold, by the finance company, which has always maintained title to the item. Also increasing is the practice were an end user purchases an item directly and then after using the item for a period of time, desires to remarket or sell the item. This senario is very similar to a lease, however, the end user is acting as the finance company. These general processes apply to any number of items, including but not limited to vehicles, both cars, trucks and buses; heavy equipment such as lifts, cranes, and fork lifts; construction vehicles; computers; and office equipment. It should be understood the items enumerated herein are intended to be exemplary and not limiting.

In its simplest form, the finance company makes a profit on a lease transaction when the lease payments during the term of the lease and the value of the item leased at the end of the lease term is greater than the purchase price of the item, including the time value of money. When the end user is acting as the finance company, the objective is not per se to make a profit but rather to minimize the costs associated with use of the item. Thus, in this situation, the end user desires to maximize the value of the item at the end of the period of use. The value of an item at the end of a period of use, whether the end of a lease term or the end of use by an end user, is generally a market value which may be determined in a number of ways, including auction, wholesale, private party negotiated transactions, or multiparty transactions such as an auction. Further background will be now be described with reference to the auction of a leased vehicle, although it should be understood that similar activity occurs no matter what item is actually used by the end user and how the market value is determined.

Typically, the auction location is a commercial vehicle auction, conveniently located to the location where the consumer surrenders possession of the vehicle. It should be understood, however, that the auction location is selected by the finance company (the owner of the vehicle), and is not necessarily the closest auction to the return location. It is then at the auction that the value of the vehicle is determined. Potential end users of the vehicles being sold are generally not well represented at such auctions. Rather, the attendees would typically include entities which would resell the vehicle after purchase at the auction.

The value of the vehicle likely varies depending on the auction location, as certain attributes of vehicles are more desirable, hence more valuable, in certain locations. A simple, but illustrative example, is that light colored vehicles may be more popular—and more valuable—in warm weather locations which receive a lot of sunshine. In the United States, such locations would be in states in the south and west of the country. Attributes other than color may also impact the value of a vehicle. For example, a vehicle with greater fuel efficiency may have more value in areas in which gas prices are high. Conversely, a vehicle with low fuel efficiency may have more value in areas in which gas prices are low. In situations such as this one, the cost of gas may increase (or decrease) in a given area on a daily basis, and thus the value of the vehicle in a given area may change on a daily basis.

There are several entities which gather valuation data from auctions. Two such entities are Kelly Blue Book (see [http:]www.kbb.com) and the National Automobile Dealers Association (NADA) (the NADA Blue Book) (see [http:]www.nada.com). Sources such as these, however, have certain deficiencies with the data they provide. For example, these sources do not break out the various options for vehicles in a manner which users of the information find to be most helpful. Furthermore, there is a lag time before the reported information is available and the information may only be reported for certain geographic location. Indeed, the NADA publishes data broken down by nine geographic regions. Moreover, the NADA lag time may range from two months to two weeks. The NADA updates its written guide on a monthly basis (the lag time necessarily being greater than one month, and due to technical constraints, more like two months). The cost for a yearly subscription for this written guide is $55.00. The NADA does make more frequently updated information available through its AuctionNet service, for which it charges $24,000 per year. In the AuctionNet service, the data comes from the weekly electronic collection of 150,000 to 200,000 auction transactions, sent in from over 140 auctions throughout the United States. The data is only reported by nine geographic regions and includes the vehicle's VIN, make, model, mileage, sale type (i.e. dealer, manufacturer, fleet lease, repo and/or salvage), sale date, sale price and N.A.D.A. region. The lag time for this data is approximately two weeks, given the need to collate the data after collection.

Information relating to valuation of vehicles may also be obtained from a system such as the one described in International Patent Application No. PCTIUS01/00941, entitled “System and Method for Remarketing Off Lease Items” and filed on Jan. 14, 2001, which is hereby incorporated by reference. Obtaining data from such a system would increase the currency of the data (data would be available in real time) and increase the number of variables associated with the data. In other words, the geographic association with the data would no longer be limited to the nine regions of the United States as reported by NADA. Obtaining data from such a system, however, would not address the problem of displaying the data in a manner which assists in valuing a particular item or vehicle.

Accordingly, a need has been recognized in connection with effectively accessing and displaying information associated with a sale of an item to assist in the valuation of similar items.

### DISCLOSURE OF THE INVENTION

In accordance with the present invention, there is provided a greatly improved system and method for effectively aggregating one or many sources of data, accessing, analyzing, and displaying information associated with a sale of an item to assist in the valuation of similar items. As broadly contemplated herein, the present invention can isolate the values associated with an item and do so through a variety of different variables. The present invention can also provide graphics that show the results of the analysis in ways that are simple to understand.

Although a presently contemplated application of the present invention and the like is in the context of vehicles, the present invention may conceivably be utilized in other contexts, such as in connection with the valuation of any item for which the owner desires to maximize the item's sale price. A presently contemplated implementation of the present invention may be written in visual basic. This implementation of the present invention can be run on any web server, including a PC, a UNIX machine, or a LINUX machine.

In summary, at least one presently preferred embodiment of the present invention broadly contemplates a method of displaying historical sales information for an item from multiple sources to assist in the valuation relating to an attribute of at least one similar item, said method comprising the steps of: formulating a report form to be applied to a data set, wherein said report form includes at least one of: screen attributes, search attributes, method attributes, and chart attributes; accessing a data set to which the report form is to be applied; applying said report form to said data set; and displaying data from said data set in accordance with said report form.

Additionally, at least one presently preferred embodiment of the present invention broadly contemplates apparatus for displaying historical sales information for an item from multiple sources to assist in the valuation relating to an attribute of at least one similar item, said apparatus comprising: an arrangement for formulating a report form to be applied to a data set, wherein said report form includes at least one of: screen attributes, search attributes, method attributes, and chart attributes; an arrangement for accessing a data set to which the report form is to be applied; an arrangement for applying said report form to said data set; and an arrangement for displaying said data in accordance with said report form.

Further, at least one presently preferred embodiment of the present invention broadly contemplates a program storage device readable by machine, tangibly embodying a program of instructions executable by the machine to perform method steps for displaying historical sales information from multiple sources for an item to assist in the valuation relating to an attribute of at least one similar item, said method comprising the steps of: formulating a report form to be applied to a data set, wherein said report form includes at least one of: screen attributes, search attributes, method attributes, and chart attributes; accessing a data set to which the report form is to be applied; applying said report form to said data set; and displaying said data in accordance with said report form.

Other further and features and embodiments of the present invention will become apparent during the course of the following discussion and by reference to the accompanying drawings.

### BRIEF DESCRIPTION OF THE DRAWINGS

FIG. 1 is a bar chart generated in accordance with the present invention.

FIG. 2 is a report generated in accordance with the present invention.

FIG. 3 is another report generated in accordance with the present invention.

FIG. 4 shows the configuration of the screen used to generate the report shown in FIG. 3.

FIG. 5 is similar to FIG. 4, but shows the configuration of the search.

FIG. 6 is similar to FIG. 5, but shows the configuration of the method.

FIG. 7 is similar to FIG. 6, but shows the configuration of the charts.

### MODES FOR CARRYING OUT THE INVENTION

A common issue in the disposition of items is the valuation of the item. The present invention is intended to assist in the valuation of the item. Preferably, the present invention includes a series of graphical displays to help the user visualize the results. In accordance with the present invention, any vehicle characteristic may be dynamically tracked and the user is allowed to specify the calculation factors and summarization methods involved in analyzing the data collected. The present invention preferably has several reporting options: web based charts, web based reports, and web based value search, which are discussed herebelow. Results may also be reported in electronic form to assist in further uses of the results.

It is contemplated in the present invention that a user who desires to analyze certain data will be located remotely from the server on which the data is located and will be electronically linked to the server on which the data is located. The link does not have to be a physical link—it can, for example, be a link via a global computer network, such as the Internet, and include a virtual private network. Preferably, the link is a global communications network, such as the Internet. Use of a global communications network reduces the cost of implementing the present invention since a private communications network need not be provided, while increasing the geographic range of potential users. Alternatively, the link can be a private communications network, or other appropriate means, such as a direct dial modem connection. The link may also be a secure link, secured for example, through cryptography. Preferably, a user will be using a common web browser, such as Internet Explorer or Netscape Navigator.

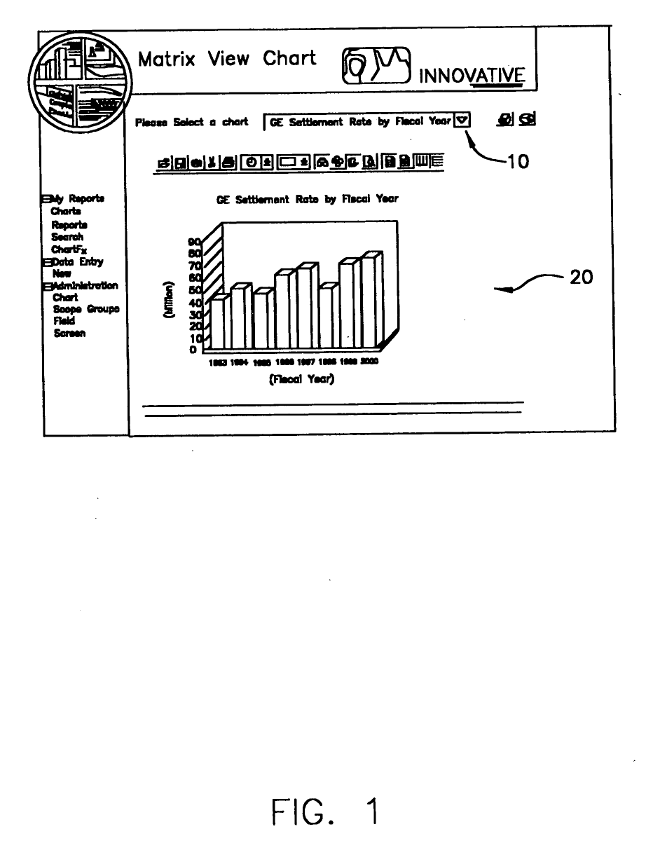

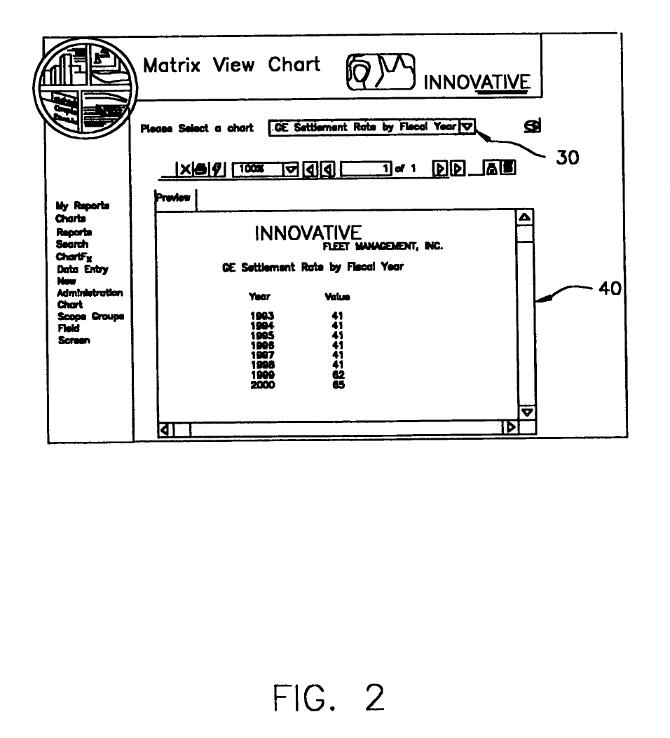

FIG. 1 is an example of a bar chart in accordance with the present invention. In this figure, a pre-configured chart is selected at reference numeral 10. The results of the chart are then displayed at reference numeral 20. It is presently preferred that ChartFx technology is used to generate the charts in a web based environment. (see [http:]www.chartfx.com) Using Chartfx technology, data may be displayed in standard business charts such as bar charts, line charts, pie charts, and many others with relative ease. FIG. 2 is an example of a report. In this figure, a pre-configured report is selected at reference numeral 30. The results of the report are then displayed at reference numeral 40. It is presently preferred that Crystal Report 8.0 be used to generate reports. This product provides users with an interface to view data results on the web and print the results to a local printer with all the standard page breaks and headers. (see [http://]www crystaldecisions.net/products/crystalreports/)

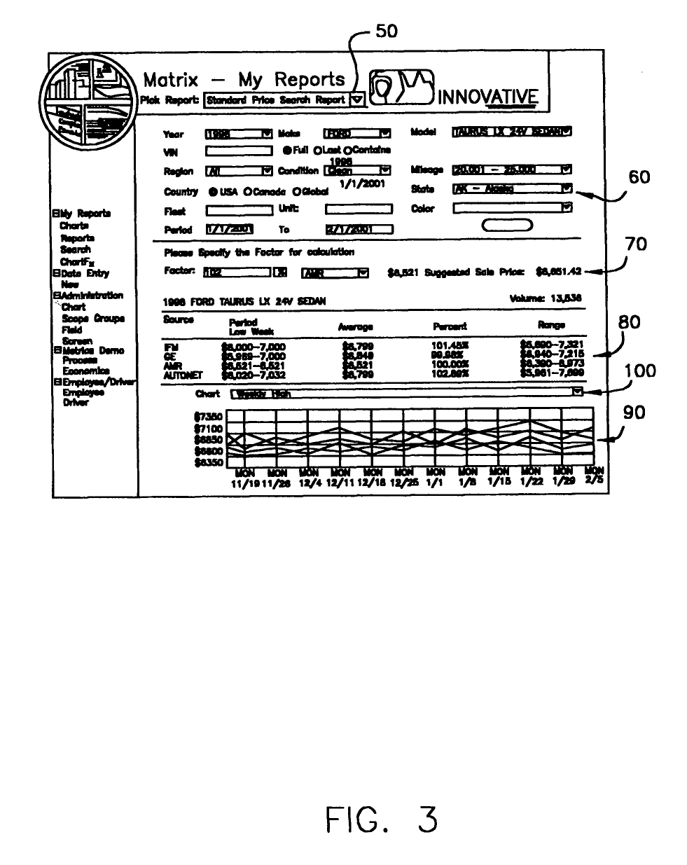

FIG. 3 is an example of the results page for a web based value search. In this report, a value is suggested for a particular item. The user selects a pre-configured report at reference numeral 50. The user then enters certain search criteria at reference numeral 60. As shown, possible search criteria include the model year, the make, the model, the vehicle identification number (VIN), the region, the state, the condition, the mileage, the color, the source fleet, the unit, the interval of time to be searched, and the country in which the vehicle is located. Additional searching criteria may also be used. At reference numeral 80 search results are shown in report form. As shown, four sources of information were searched. The range of historical values is presented, along with the average. One of the sources is preferably used as a benchmark and the results compared to that source are also presented. The fifty two week low and high are also shown. At reference numeral 90, the historical values are presented in line chart form. The information to be displayed in chart form is selected at reference numeral 100. As shown in FIG. 3, the weekly high is shown for each information source. At reference numeral 70, a suggested sale price is shown. As shown, this suggested sale price is determined based on one hundred and two percent (102%) of value from a selected data source (in this case AMR). The factor is selected by the user, as is the data source to be used. A user may prefer, however, to compute the suggested sale price in another manner based upon the user's own experience. The arrangement of information as shown in this figure is preferable, as it presents information in a format that increases comprehension of the information.

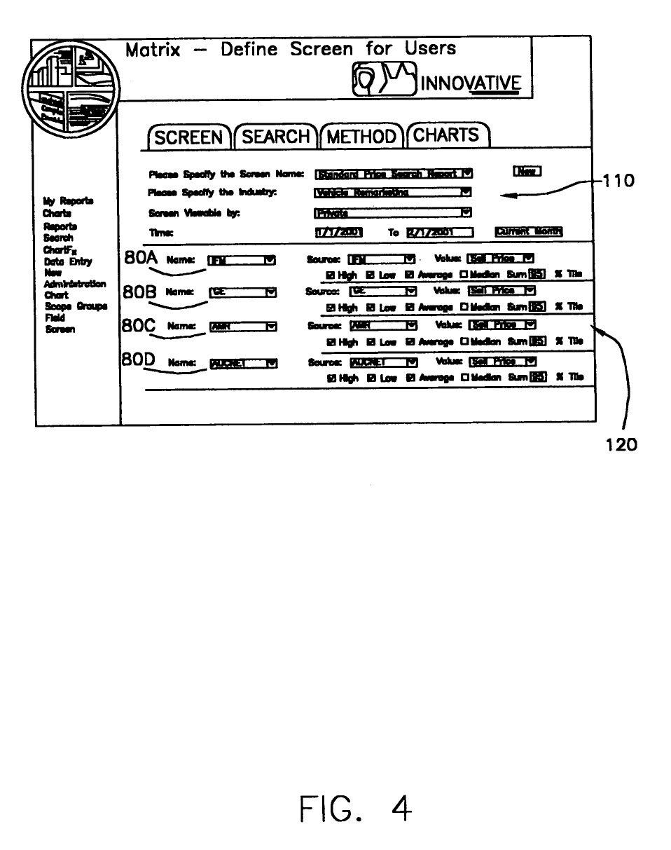

One advantage of the present invention is that the display of information is configurable by the user. FIGS. 4-7 are related to the configuration which produced the report as shown in FIG. 3. The various components which are preferably configurable include the screen, the search, the method, and the charts.

FIG. 4 shows the configuration of the screen. At reference numeral 110, certain criteria are specified, including the name of the report, the industry to which the report applies, the group of users who may view the report (as shown it is a private report, viewable only by the creator), and the time period of interest. Reference numeral 120 shows where the sources of information are selected and their attributes are chosen. These sources are denoted by reference numerals 80a, 80b, 80c, and 80d, and their name may be selected, the source assigned, the value to be displayed chosen, along with attributes of the value to be displayed. As shown, the source of information at reference numeral 80a is a system such as the one described in International Patent Application No. PCT/US01/00941, entitled “System and Method for Remarketing Off Lease Items” and filed on Jan. 14, 2001, discussed above. The source of information at reference numeral 80b is from the owner of the items to be valued. Typically the owner of items has historical information on the items it has previously sold; this is particularly true where the owner of the items is a finance company. The source of information at reference numeral 80c is the Automotive Market Report, a supplier of information similar to the NADA (discussed above), with an emphasis on information relating to the sale of fleet vehicles. The source of information at reference numeral 80d is the AuctionNet service offered by the NADA, discussed above.

Other sources of information may also be used in addition to or as a replacement for any of the sources discussed above. Examples of other sources of information include NADA and Black Book. NADA is discussed above, and would be used in addition to AucNet data to include additional transactions not included in the AucNET data, such as dealer transactions. Black Book data is provided by the National Auto Research Division of the Hearst Business Media Corporation, which visually inspect vehicles and chronicles their selling price throughout North America every week. There are, however, additional sources of information.

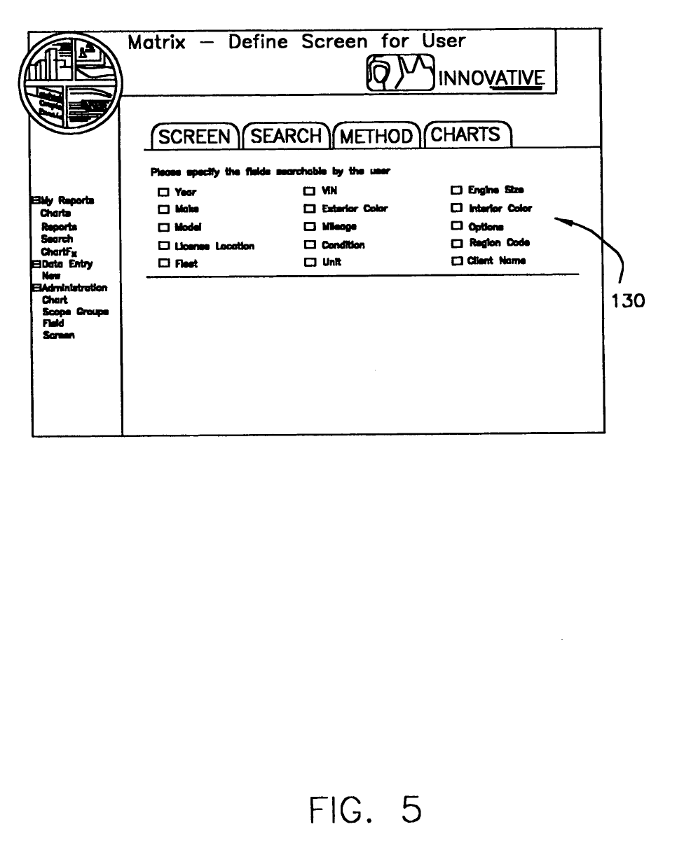

FIG. 5 shows the configuration of the search. At reference numeral 130, it is possible to select those fields which are searchable by a user of the report. As shown, no fields are selected as being searchable. FIG. 3, however, shows a report with fields that have been selected as being searchable. As shown in FIG. 5, the possible fields to be searched by a user include year, vehicle identification number (VIN), engine size, make, exterior color, interior color, model, mileage, options, license location, condition, region code, fleet, unit, and client name.

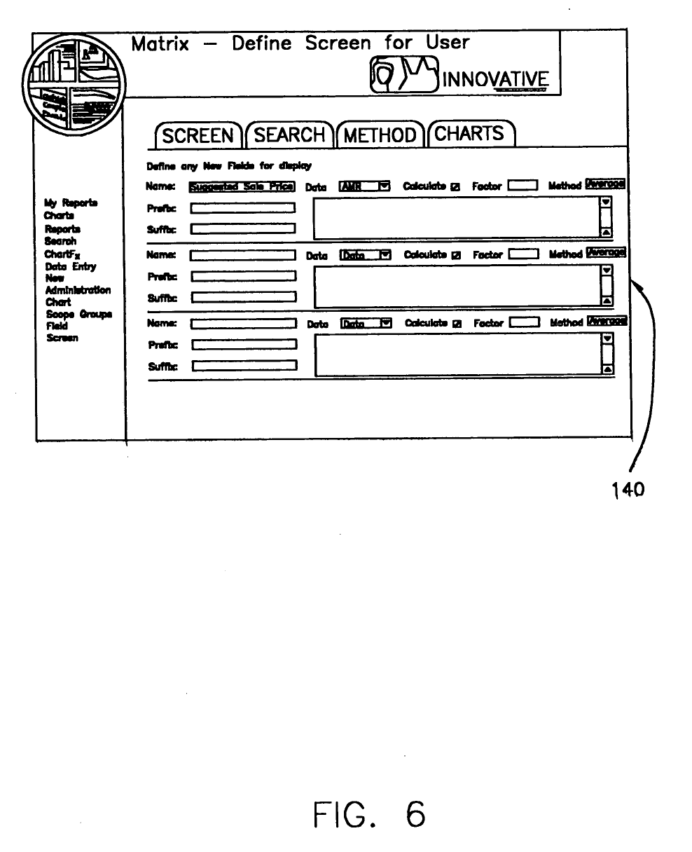

FIG. 6 shows the configuration of the method used to generate the suggested sale price, which appears in FIG. 3. At reference numeral 140 the result is named (suggested sale price), the data source is selected, and the method used is also selected. As shown, the method to be used is the average. In accordance with this method, the price is calculated as adding the sale price associated with each transaction and dividing by the total number of transactions. Another preferred method is 3 Sigma. In accordance with the 3 Sigma method, the calculated price is the arithmetic average of all sale prices within three standard deviations of the mean of all sale prices. Other appropriate methods may also be used. The factor to be used may also be entered. While the factor has not been selected in this figure, the factor used in FIG. 3 is 102. A prefix and a suffice may also be entered. These items are used for identifying characters which appear before and after the field or result to be displayed. While no prefix or suffix is shown in FIG. 6, an example of a prefix is the dollar sign (“$”) and an example of a suffix is the percent sign (“%”). A prefix and suffix is preferably selected by the user when appropriate.

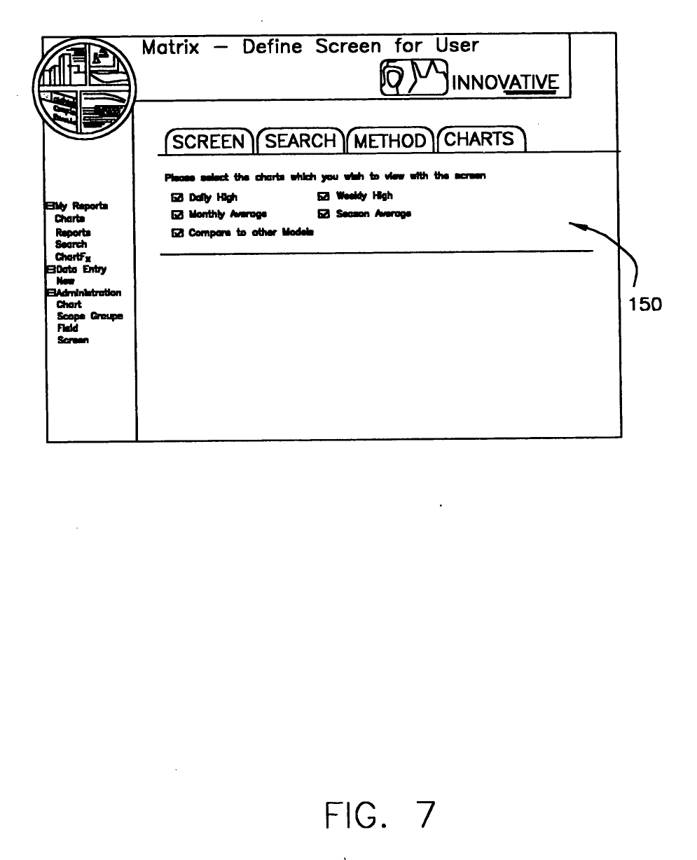

FIG. 7 shows the configuration of the charts which may be selected at reference numeral 100 in FIG. 3. It should be noted that only those charts which have previously been created are shown. Those charts which are shown are those that are presently preferred, although additional charts may be created. As shown at reference numeral 150, the preferred charts are daily high, weekly high, monthly average, seasonal average, and compare to other models. A daily high chart shows the highest sale price in a day. A weekly high chart shows the highest sale price in a week, which is preferably a calendar week. A monthly average chart shows the average sale price in a month, which is preferably a calendar month. The average price may be calculated using the methods discussed above, or by any appropriate method. A seasonal average chart shows the average price for a defined season. Again the average price may be calculated using the methods discussed above, or by any appropriate method. A season may be any interval of time appropriate for item being evaluated. For vehicles, a season is preferably a three month interval, with the seasons being as follows: November, December, January (Winter); February, March, April (Spring); May, June, July (Summer); and August, September, October (Fall). A compare to other models chart shows the sale price of like or competitive vehicles. Is An example of when this chart would be used is when a comparison of the same vehicle with different trim levels is desired. FIG. 3 shows weekly high being selected at reference numeral 100, with the information being displayed in line chart form at reference numeral 90.

It is to be understood that the present invention may implemented on at least one general-purpose computer running suitable software programs. These may also be implemented on at least one Integrated Circuit or part of at least one Integrated Circuit. Thus, it is to be understood that the invention may be implemented in hardware, software, or a combination of both.

If not otherwise stated herein, it is to be assumed that all patents, patent applications, patent publications and other publications (including web-based publications) mentioned and cited herein are hereby fully incorporated by reference herein as if set forth in their entirety herein.

While there have been described what are believed to be the preferred embodiments of the invention, those skilled in the art will recognize that other and further modifications may be made thereto without departing from the invention and it is intended to claim all such changes and modifications as fully within the scope of the invention.

What is claimed is:

1. A method of displaying historical sales information for an item from multiple sources to assist in the valuation relating to an attribute of at least one similar item, said method comprising the steps of:
formulating a report form to be applied to a data set, wherein said report form includes at least one of: screen attributes, search attributes, method attributes, and chart attributes;
accessing a data set to which the report form is to be applied;
applying said report form to said data set; and
displaying data from said data set in accordance with said report form.

2. The method of claim 1, wherein said report form comprises all of said screen attributes, search attributes, method attributes, and chart attributes.

3. The method according to claim 1, wherein the report form is formulated remotely from the data set.

4. The method according to claim 1, wherein the report form comprises screen attributes, the screen attributes comprising information relating to the source of the data in the data set to be displayed.

5. The method according to claim 1, wherein the report form comprises search attributes, the search attributes comprising information relating to searchable fields within the data set.

6. The method according to claim 1, wherein the report form comprises method attributes, the method attributes comprising information relating to a method used to determine a given result displayed in the report.

7. The method according to claim 1, wherein the report form comprises chart attributes, the chart attributes comprising information relating to charts which are available for display in the report.

8. The method according to claim 1, wherein said step of accessing a data set to which the report form is to be applied comprises providing at least one security arrangement associated with the data set.

9. The method according to claim 8, wherein said step of providing at least one security arrangement comprises providing an electronic cryptographic arrangement associated with the data set.

10. An apparatus for displaying historical sales information for an item from multiple sources to assist in the valuation relating to an attribute of at least one similar item, said apparatus comprising:
an arrangement for formulating a report form to be applied to a data set, wherein said report form includes at least one of: screen attributes, search attributes, method attributes, and chart attributes;
an arrangement for accessing a data set to which the report form is to be applied;
an arrangement for applying said report form to said data set; and
an arrangement for displaying said data in accordance with said report form.

11. The apparatus according to claim 10, wherein said report form comprises all of said screen attributes, search attributes, method attributes, and chart attributes.

12. The apparatus according to claim 10, wherein the report form is formulated remotely from the data set.

13. The apparatus according to claim 10, wherein the report form comprises screen attributes, the screen attributes comprising information relating to the source of the data in the data set to be displayed.

14. The apparatus according to claim 10, wherein the report form comprises search attributes, the search attributes comprising information relating to searchable fields within the data set.

15. The apparatus according to claim 10, wherein the report form comprises method attributes, the method attributes comprising information relating to a method used to determine a given result displayed in the report.

16. The apparatus to claim 10, wherein the report form comprises chart attributes, the chart attributes comprising information relating to charts which are available for display in the report.

17. The apparatus according to claim 10, wherein said step of accessing a data set to which the report form is to be applied comprises providing at least one security arrangement associated with the data set.

18. The apparatus according to claim 17, wherein said step of providing at least one security arrangement comprises providing an electronic cryptographic arrangement associated with the data set.

19. A program storage device readable by machine for tangibly embodying a program of instructions executable by said machine to perform a method of displaying historical sales information from multiple sources for an item to assist in the valuation relating to an attribute of at least one similar item, said method comprising the steps of:
formulating a report form to be applied to a data set, wherein said report form includes at least one of: screen attributes, search attributes, method attributes, and chart attributes;
accessing a data set to which the report form is to be applied;
applying said report form to said data set; and
displaying said data in accordance with said report form.
